(19) United States
(12) Patent Application Publication
(10) Pub. No.: US 2008/0282840 A1
(43) Pub. Date: Nov. 20, 2008

(54) Drive Shaft Moving Device

(76) Inventor: Toshiaki Shimada, Hiroshima (JP)

Correspondence Address: Studebaker & Brackett PC, 1890 Preston White Drive, Suite 105, Reston, VA, 20191, US

(21) Appl. No.: 10/581,548

(22) PCT Filed: Sep. 20, 2005
(86) PCT No.: PCT/JP05/17306

§ 371 Date: Jun. 2, 2006

(51) Int. Cl. F16H 35/18

(52) U.S. Cl. 74/841

(57) ABSTRACT

A nut 4 is provided inside a casing 3 through which a drive shaft 2 having a thread groove 2a is inserted. The nut 4 is meshed with the drive shaft 2. The nut 4 is provided with an internal gear 25 which surrounds the drive shaft 2. A spur gear 36 is fixed to an eccentric part 37 of an output shaft 27 of a motor 5. The spur gear 36 and the internal gear 25 are meshed with each other to form a speed reduction mechanism 6. An electromagnetic clutch 7 is fixed to the output shaft 27. The electromagnetic clutch 7 switches the operation between two operation modes. In the first mode, the output shaft 27 is connected to the nut 4 such that the nut 4 rotates at a speed equal to the rotation speed of the output shaft 27. In the second mode, the output shaft 27 is disconnected from the nut 4 such that the nut 4 is rotated while the rotation speed of the output shaft 27 is reduced by the speed reduction mechanism 6.

### TECHNICAL FIELD

The present invention relates to a device for moving a drive shaft which is used in various industrial machinery, for example, machine tools, robots, etc.

### BACKGROUND ART

Conventionally, a drive shaft moving device of this type has been known wherein a drive shaft with a thread groove in its external surface is inserted through the principal part of the device and at the same time inserted through a nut provided inside the principal part of the device, and the nut is rotated by a motor around the drive shaft such that the drive shaft is axially moved relative to the principal part of the device (see, for example, Patent Document 1). This drive shaft moving device has a gear for speed reduction between an output shaft of the motor and the nut. This speed reduction gear decreases the rotation speed of the nut to be lower than that of the output shaft of the motor, thereby increasing the torque of the nut. As a result, it is possible to increase the thrust of the drive shaft. Patent Document 1 also discloses providing a speed increasing gear between the output shaft of the motor and the nut. This speed increasing gear increases the rotation speed of the nut to be faster than that of the output shaft of the motor, thereby increasing the propulsion speed of the drive shaft. That is, a machine having a drive shaft which is required to be moved with a large thrust employs a moving device which has a speed reduction gear, whereas a machine having a drive shaft which is required to be moved with a fast propulsion speed employs a moving device which has a speed increasing gear.

[Patent Document 1] Japanese Laid-Open Patent Publication No. 2003-343679

### DISCLOSURE OF INVENTION

### Problems to be Solved by the Invention

If the drive shaft moving device of Patent Document 1 is applied to a press molding machine which is an example of the various machinery, the drive shaft is fixed to a press die, and the press die is moved by the thrust of the drive shaft. In this case, the following is demanded: the propulsion speed of the drive shaft is increased immediately before closure of the dies to shorten the travel time of the press die and, thereafter, the thrust of the drive shaft is increased during the pressing process to produce a sufficient pressing force.

However, the moving devices disclosed in Patent Document 1 have the following disadvantages. The moving device having a speed reduction gear can produce large thrust but cannot achieve high propulsion speed so that the travel time of the press die cannot be shortened. The moving device having a speed increasing gear can achieve high propulsion speed but cannot produce a large thrust which is required during the pressing process. Therefore, the drive shaft moving devices disclosed in Patent Document 1 are not suitable for a machine which is required to change the propulsion speed or thrust during the travel of the drive shaft as in the above-described press molding machine. Thus, such moving devices are only applicable to a narrow range of uses and have poor versatility.

The present invention was conceived in view of the above circumstances. An objective of the present invention is to provide a drive shaft moving device of improved versatility wherein the propulsion speed and thrust of the drive shaft can be changed during the travel of the drive shaft.

### Means for Solving the Problems

To achieve the above objective, according to the present invention, the rotation speed of a nut can be switched among a plurality of rotation speeds when transmitting the torque from drive means to the nut.

Specifically, the first invention is directed to a drive shaft moving device, comprising: a principal part of the device through which a drive shaft is inserted, the drive shaft having a thread groove in its external surface; a nut provided inside the principal part of the device to engage with the thread groove of the drive shaft; and drive means for rotating the nut around the drive shaft, the drive means rotating the nut to move the drive shaft in an axial direction relative to the principal part of the device, wherein the inside of the principal part of the device includes rotation speed switching means for switching the rotation speed of the nut among a plurality of rotation speeds when transmitting a torque from the drive means to the nut.

In the above structure, for example, when the nut rotating at a speed equal to the rotation speed of the drive means is reduced in rotation speed by the rotation speed switching means, the propulsion speed of the drive shaft is decreased while the thrust of the drive shaft is increased. This also applies to a case where the nut rotating at a speed higher than the rotation speed of the drive means is reduced in rotation speed by the rotation speed switching means.

When the nut rotating at a speed equal to the rotation speed of the drive means is increased in rotation speed by the rotation speed switching means, the propulsion speed of the drive shaft is increased. This also applies to a case where the nut rotating at a speed lower than the rotation speed of the drive means is increased in rotation speed by the rotation speed switching means.

According to the second invention, in the first invention, the drive shaft is located to penetrate through the rotation speed switching means.

In the above structure, the rotation speed switching means does not obstruct the travel of the drive shaft.

According to the third invention, in the first or second invention, the rotation speed switching means includes a speed reduction mechanism for reducing the rotation speed of an output shaft of the drive means.

In the above structure, it is possible to decrease the propulsion speed of the drive shaft while increasing the thrust of the drive shaft during the travel of the drive shaft.

According to the fourth invention, in the third invention, the nut has an annular part surrounding the drive shaft; the drive shaft is inserted through the output shaft of the drive means; and the speed reduction mechanism includes follower teeth formed by internal teeth provided on an inner periphery of the annular part and driver teeth provided on the outer periphery of the output shaft to mesh with the follower teeth.

In the above structure, the driver teeth are provided inwardly of the annular part of the nut, and the meshing of the driver teeth and the follower teeth reduces the rotation speed of the output shaft of the drive means.

According to the fifth invention, in the first or second invention, the nut has an annular part surrounding the drive shaft; the drive means has an output shaft through which the drive shaft is inserted; and the rotation speed switching means includes follower teeth formed by internal teeth provided on an inner periphery of the annular part, driver teeth provided on the outer periphery of the output shaft to mesh with the follower teeth, and clutching means integrally rotatable with the output shaft for switching the connection/disconnection between the output shaft and the nut.

In the above structure, when the output shaft and the nut are connected by the clutching means, the nut rotates at a speed equal to the rotation speed of the output shaft. On the other hand, when the output shaft and the nut are disconnected by the clutching means, the torque of the output shaft is transmitted from the driver teeth of the output shaft to the follower teeth of the nut. Thus, the rotation speed of the nut is changed relative to the rotation speed of the output shaft at the gear ratio set by the driver teeth and the follower teeth.

According to the sixth invention, in the first or second invention, the nut has an annular part surrounding the drive shaft; the drive means has an output shaft through which the drive shaft is inserted; and the rotation speed switching means includes a cylindrical rotary member supported rotatably around the output shaft, first follower teeth formed by internal teeth provided on an inner periphery of the annular part of the nut, first driver teeth provided on the outer periphery of the rotary member to mesh with the first follower teeth, second follower teeth provided on an inner periphery of the rotary member, second driver teeth provided on the outer periphery of the output shaft to mesh with the second follower teeth, and clutching means integrally rotatable with the output shaft for switching the connection/disconnection between the output shaft and the rotary member.

In the above structure, when the output shaft and the rotary member are connected by the clutching means, the rotary member rotates at a speed equal to the rotation speed of the output shaft. The rotation speed of the nut is changed relative to the rotation speed of the output shaft at the gear ratio set by the first driver teeth and the first follower teeth.

On the other hand, when the output shaft and the rotary member are disconnected by the clutching means, the torque of the output shaft is transmitted from the second driver teeth of the output shaft to the second follower teeth of the rotary member. Thus, the rotation speed of the rotary member is changed relative to the rotation speed of the output shaft at the gear ratio set by the second driver teeth and the second follower teeth. In the meantime, the torque of the rotary member is transmitted from the first driver teeth of the rotary member to the first follower teeth of the nut. Thus, the rotation speed of the nut is changed relative to the rotation speed of the rotary member at the gear ratio set by the first driver teeth and the first follower teeth.

### EFFECTS OF THE INVENTION

According to the first invention, the rotation speed of a nut can be switched among a plurality of rotation speeds when transmitting the torque from drive means to the nut. Therefore, the propulsion speed and thrust can be changed during the travel of the drive shaft. As a result, the versatility of the driver shaft moving device is improved.

According to the second invention, the driver shaft penetrates through the rotation speed switching means. Therefore, a limitation on the amount of travel of the drive shaft by the rotation speed switching means is avoided.

According to the third invention, the rotation speed switching means includes a speed reduction mechanism. Therefore, even when a low-power, small-sized, light-weight driver is used as the drive means, the drive shaft can be moved with a sufficient thrust.

According to the fourth invention, the driver teeth are provided inwardly of the annular part, and the driver teeth is meshed with the follower teeth. Therefore, the speed reduction mechanism can be compactly structured.

According to the fifth invention, the follower teeth of the nut are meshed with the driver teeth of the output shaft, and the connection/disconnection between the output shaft and the nut is switched by the clutching means. Therefore, the rotation speed of the nut can be switched between two speeds using a pair of follower teeth and driver teeth.

According to the sixth invention, the first follower teeth of the nut are meshed with the first driver teeth of the rotary member, and the second follower teeth of the rotary member are meshed with the second driver teeth of the output shaft. Further, the connection/disconnection between the output shaft and the rotary member is switched by the clutching means. Therefore, the rotation speed of the nut can be set by two gear ratios, i.e., the gear ratio between the output shaft and the rotary member and the gear ratio between the rotary member and the nut. Thus, the flexibility in setting the rotation speed of the nut is improved, and the versatility of the moving device is further improved.

### BRIEF DESCRIPTION OF DRAWINGS

FIG. 1 illustrates an operation of a drive shaft moving device according to embodiment 1 of the present invention.

FIG. 2 is a cross-sectional view taken along line A-A of FIG. 1.

FIG. 3 is a block diagram of a drive shaft moving device.

FIG. 4 is a cross-sectional view showing a drive shaft moving device according to embodiment 2 of the present invention (corresponding to FIG. 2).

### DESCRIPTION OF REFERENCE NUMERALS

1 Moving device
2 Drive shaft
2a Thread groove
3 Casing (Principal part of device)
4 Nut
5 Motor (Drive means)
6 Speed reduction mechanism
7 Electromagnetic clutch (Clutching means)
25 Internal gear (Annular part)
25a Teeth (Follower teeth, First follower teeth)
27 Output shaft
36 Spur gear
36c Teeth (Driver teeth)
61 Rotary member
65 Teeth (First driver teeth)
70 Teeth (Second follower teeth)
71 Spur gear
71c Teeth (Second driver teeth)

### BEST MODE FOR CARRYING OUT THE INVENTION

Hereinafter, embodiments of the present invention will be described with reference to the drawings.

### Embodiment 1

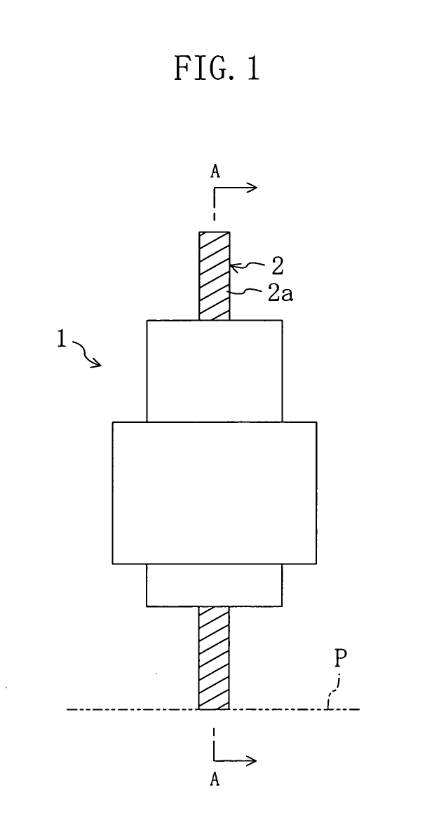

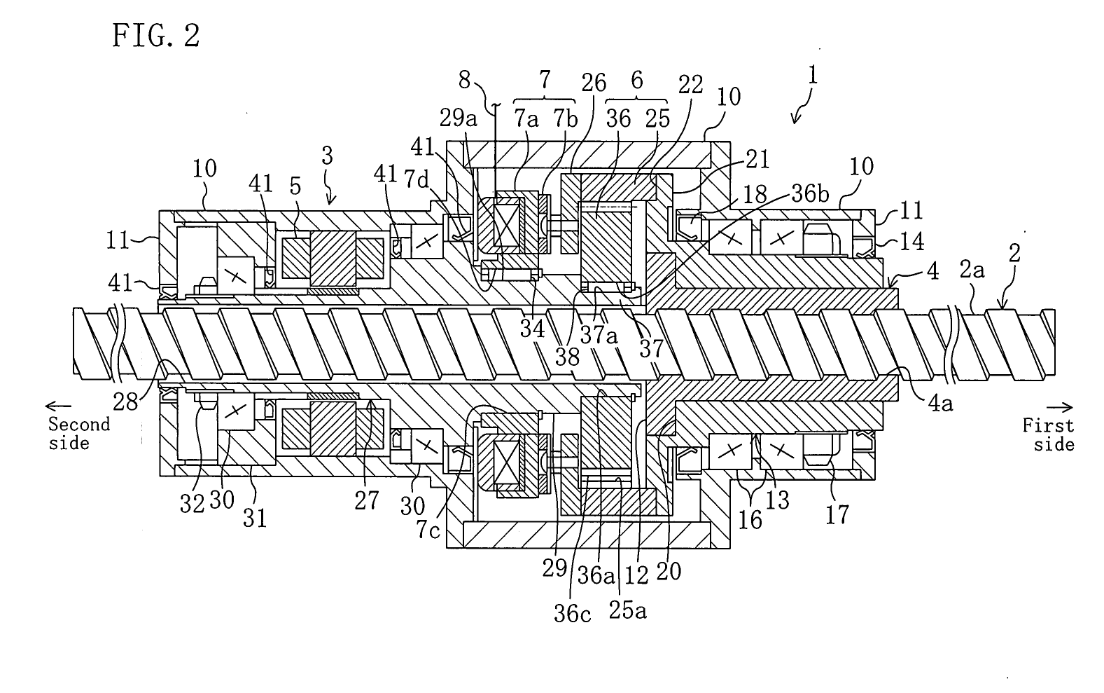

FIG. 1 shows the use of a drive shaft moving device 1 according to embodiment 1 of the present invention for moving a press die P of a press molding machine. A drive shaft 2 is formed by a trapezoidal screw shaft which has a thread groove 2a in its external surface. The drive shaft 2 extends in a direction generally perpendicular to the traveling direction of the press die P. One end of the drive shaft 2 (the lower end in FIG. 1; the right end in FIG. 2) is fixed to the press die P. Therefore, the press die P is moved by axially moving the drive shaft 2.

The moving device 1 has a casing 3 (the principal part of the moving device) which is formed such that the drive shaft 2 is inserted through the casing 3 as also shown in FIG. 2. The inside of the casing 3 includes a nut 4 engaged with the thread groove 2a of the drive shaft 2, a motor 5 (drive means) for rotating the nut 4, a speed reduction mechanism 6 for reducing the rotation speed of the motor 5, and an electromagnetic clutch 7 for switching the connection/disconnection between the motor 5 and the nut 4. The nut 4, the motor 5, the speed reduction mechanism 6 and the electromagnetic clutch 7 are constituents of the moving device 1. It should be noted that, in FIG. 2, reference number 8 denotes a wiring for controlling the electromagnetic clutch 7.

The casing 3 generally has a cylindrical shape which extends in the axial direction of the drive shaft 2 and is formed by three longitudinally-coupled divisional components 10. A longitudinal end of the casing 3 (right end in FIG. 2; hereinafter “first end”) and the other end thereof (left end in FIG. 2; hereinafter “second end”) each have an opening. Each of the first and second ends of the casing 3 has a disk-like lid 11 through which the drive shaft 2 is inserted.

The nut 4 is a trapezoidal screw nut whose axial length is about a ⅓ of the axial length of the casing 3. The nut 4 is located inside the casing 3 on the first end side. The internal surface of the nut 4 has a spiral protruding rail 4a which corresponds to the thread groove 2a of the drive shaft 2 such that the spiral protruding rail 4a is meshed with the thread groove 2a. An end (first end) of the nut 4 penetrates through the lid 11 to extend out of the casing 3. The other end (second end) of the nut 4 has a flange 12.

The external surface of the nut 4 is covered by a cylindrical member 13 which is coaxial with the drive shaft 2 such that the nut 4 is fixedly fit in the cylindrical member 13. The nut 4 and the cylindrical member 13 are integral such that no slippage occurs in any of the axial direction and the circumferential direction. An end (first end) of the cylindrical member 13 penetrates through the lid 11 to extend out of the casing 3. At the first end of the cylindrical member 13, a sealing member 14 is provided between the external surface of the cylindrical member 13 and the lid 11.

The external surface of the cylindrical member 13 is provided with two bearings 16 which are aligned in the axial direction of the cylindrical member 13 with a space therebetween. The bearings 16 are fixed to the cylindrical member 13 with a screw member 17 which screws in the first end of the cylindrical member 13. The external surfaces of the bearings 16 are supported on the internal surface of the component 10 of the casing 3. The cylindrical member 13 rotates around the axis of the casing 3. It should be noted that reference number 18 denotes a sealing member.

At the other end (second end) of the cylindrical member 13, the internal surface of the cylindrical member 13 has an internal step 20 in which the flange 12 of the nut 4 fits. When the nut 4 is integral with the cylindrical member 13, the end surface of the second end of the nut 4 and the end surface of the second end of the cylindrical member 13 are generally on the same plane. The second end of the cylindrical member 13 has a radially outwardly extending annular extended part 21 which is formed integrally with the cylindrical member 13. The circumference of the extended part 21 has an external step 22.

Inside the casing 3, an internal gear 25 is provided on the second side relative to the cylindrical member 13. The internal gear 25 has an annular shape which surrounds the drive shaft 2 and is located coaxially with the drive shaft 2. An axial side (first side) of the internal gear 25 is fixedly fit in the external step 22 of the cylindrical member 13. The internal gear 25 is integrated with the nut 4 together with the cylindrical member 13 interposed therebetween. That is, the internal gear 25 constitutes an annular part of the nut 4. Teeth 25a of the internal gear 25 constitute follower teeth. The number of teeth 25a of the internal gear 25, Z1, is set to, for example, 50.

At the other axial side (second side) of the internal gear 25, an end surface of the internal gear 25 is provided with a clutch plate fixing member 26 to which a clutch plate 7b of the electromagnetic clutch 7 is fixed. The clutch plate fixing member 26 has an annular shape and is located coaxially with the drive shaft 2.

Inside the casing 3, an output shaft 27 of the motor 5 is provided on the second side. The output shaft 27 is a hollow shaft having a through hole 28 through which the drive shaft 2 is inserted. A longitudinal end (first side end) of the output shaft 27 has a large diameter part 29 whose diameter is larger than the other end. The external surface of the output shaft 27 is provided with bearings 30 at the longitudinal other end (second side end) and the central part. The second side end of the output shaft 27 is provided with a screw member 32 which screws in the output shaft 27 for fixing the bearing 30. An annular supporting member 31 is provided between the external surface of the bearing 30 on the second side and the internal surface of the casing 3. The external surface of the bearing 30 at the central part is supported by the component 10 of the casing 3. The output shaft 27 rotates around the axis of the casing 3 independently of the nut 4.

Between the two bearings 30 which support the output shaft 27 is the principal part of the motor 5 which has a well-known structure. When the principal part of the motor 5 is powered, the output shaft 27 rotates. The output shaft 27 and the principal part constitute the motor 5. The motor 5 is a so-called servo motor.

The first side part of the output shaft 27 is provided with the electromagnetic clutch (clutching means) 7 at a position closer to the first side than the bearings 30. The electromagnetic clutch 7 has a well-known structure including the clutch plate 7b and a principal part 7a. The principal part 7a of the electromagnetic clutch 7 has a central hole 7c at the center, through which the large diameter part 29 of the output shaft 27 is inserted. The internal surface of the central hole 7c and the external surface of the large diameter part 29 of the output shaft 27 have keyways 7d and 29a, respectively. A key 34 is inserted to the keyways 7d and 29a. With this, the principal part 7a of the electromagnetic clutch 7 is fixed to the output shaft 27 and rotates together with the output shaft 27. It should be noted that reference number 41 denotes a sealing member.

The first side part of the output shaft 27 is provided with a spur gear 36 inwardly of the internal gear 25 at a position closer to the first side than the electromagnetic clutch 7. The spur gear 36 has a smaller diameter than that of the internal gear 25. The number of teeth 36c of the spur gear 36, Z2, is set to a number smaller than the number of teeth 25a of the internal gear 25 (Z1), e.g., 49. The large diameter part 29 of the output shaft 27 has an eccentric part 37 which is inserted through a central hole 36a of the spur gear 36. The geometric center of the eccentric part 37 is misaligned from the rotation axis of the output shaft 27. The amount of this misalignment of the geometric center is set such that some of the teeth 36c of the spur gear 36 mesh with some of the teeth 25a of the internal gear 25. The internal surface of the central hole 36a of the spur gear 36 and the external surface of the eccentric part 37 of the output shaft 27 have keyways 36b and 37a, respectively. A key 38 is inserted to the keyways 36b and 37a. With this, the spur gear 36 is fixed to the output shaft 27 and rotates according to the rotation of the output shaft 27 eccentrically with respect to the rotation center of the output shaft 27. The torque of the output shaft 27 is transmitted to the internal gear 25 through the spur gear 36. In this process, the rotation speed of the output shaft 27 is reduced at the gear ratio of 1/50 which is set by the number of teeth 36c of the spur gear 36 (Z2) and the number of teeth 25a of the internal gear 25 (Z1). The internal gear 25 and the spur gear 36 constitute the speed reduction mechanism 6.

The number of teeth 36c of the spur gear 36 (Z2) and the number of teeth 25a of the internal gear 25 (Z1) may be arbitrarily set. In such a case, the interval of teeth, the shape of each tooth, etc., may be changed using a generally-employed, well-known gear designing method.

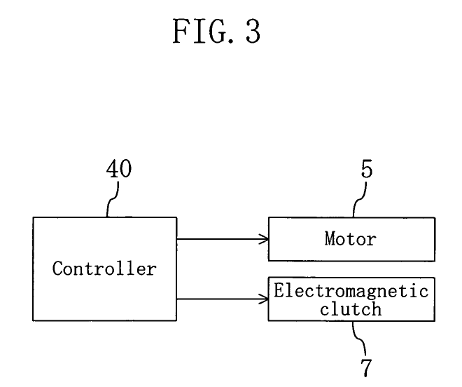

As shown in FIG. 3, the motor 5 and the electromagnetic clutch 7 are connected to a controller 40. The controller 40 is manipulated by an operator of the press molding machine. The controller 40 switches the operation of the motor 5 between ON and OFF, switches the revolution direction of the motor 5, and switches the operation of the electromagnetic clutch 7 between ON and OFF.

In the moving device 1 having the above-described structure, when the controller 40 turns ON the electromagnetic clutch 7, the clutch plate 7b and the principal part 7a are integrated. As a result, the output shaft 27 is connected to the nut 4 by the electromagnetic clutch 7, the clutch plate fixing member 26, the internal gear 25 and the cylindrical member 13. When the controller 40 turns ON the motor 5 so that the output shaft 27 starts rotating, the torque of the output shaft 27 is transmitted to the nut 4 through the electromagnetic clutch 7, the clutch plate fixing member 26, the internal gear 25 and the cylindrical member 13. Since the output shaft 27 is connected to the nut 4 at this time, the speed reduction mechanism 6 does not work so that the nut 4 rotates at a rotation speed equal to that of the output shaft 27. When the nut 4 rotates, the drive shaft 2 moves in an axial direction relative to the casing 3 because the drive shaft 2 is fixed to the press die P so as not to rotate. As a result, the press die P travels.

On the other hand, when the controller 40 turns OFF the electromagnetic clutch 7, the clutch plate 7b retreats from the principal part 7a so that the output shaft 27 is disconnected from the nut 4. When the controller 40 turns ON the motor 5 so that the output shaft 27 starts rotating, the torque of the output shaft 27 is transmitted from the spur gear 36 to the internal gear 25 and then transmitted to the nut 4 through the cylindrical member 13. In this process, the rotation speed of the nut 4 is reduced at the gear ratio between the internal gear 25 and the spur gear 36 to be lower than the rotation speed of the output shaft 27 while the torque of the nut 4 increases. As a result, the propulsion speed of the drive shaft 2 decreases while the thrust of the drive shaft 2 increases. Thus, a sufficient pressing force can be obtained during the pressing process. Therefore, the propulsion speed of the drive shaft 2 is increased immediately before closure of the die of the press molding machine to shorten the travel time of the press die P and, thereafter, the thrust of the drive shaft 2 is increased during the pressing process to produce a sufficient pressing force while decreasing the propulsion speed. The electromagnetic clutch 7, the internal gear 25 and the spur gear 36 constitute rotation speed switching means for switching the rotation speed of the nut 4 among a plurality of rotation speeds when transmitting the torque from the motor 5 to the nut 4.

In the drive shaft moving device 1 according to embodiment 1, when transmitting the torque of the output shaft 27 of the motor 5 to the nut 4, the rotation speed of the nut 4 can be switched between two speeds by switching the operation of the electromagnetic clutch 7 between ON and OFF. With this, the range of uses of the moving device 1 expands, and the versatility of the moving device 1 improves.

Since the drive shaft 2 is inserted through the electromagnetic clutch 7, the spur gear 36 and the internal gear 25, the electromagnetic clutch 7, the spur gear 36 and the internal gear 25 do not obstruct the travel of the drive shaft 2. Therefore, the amount of travel of the drive shaft 2 can be sufficiently secured.

Since the thrust of the drive shaft 2 can be increased by the speed reduction mechanism 6, the drive shaft 2 can be moved with a sufficient thrust even if the motor 5 is a lower-power, small-sized, light-weight motor.

Since the spur gear 36 is located inwardly of the internal gear 25 such that the spur gear 36 meshes with the internal gear 25, the speed reduction mechanism 6 can be compactly structured.

The internal gear 25 of the nut 4 is meshed with the spur gear 36 of the output shaft 27, and the electromagnetic clutch 7 switches the connection/disconnection between the output shaft 27 and the nut 4. Therefore, the rotation speed of the nut 4 can be switched between two speeds using a pair of gears.

Although embodiment 1 employs the speed reduction mechanism 6 for reducing the rotation speed of the output shaft 27, a speed increasing mechanism may be provided in place of the speed reduction mechanism 6. The speed increasing mechanism may be realized by setting the number of teeth 36c of the spur gear 36 (Z2) larger than the number of teeth 25a of the internal gear 25 (Z1).

### Embodiment 2

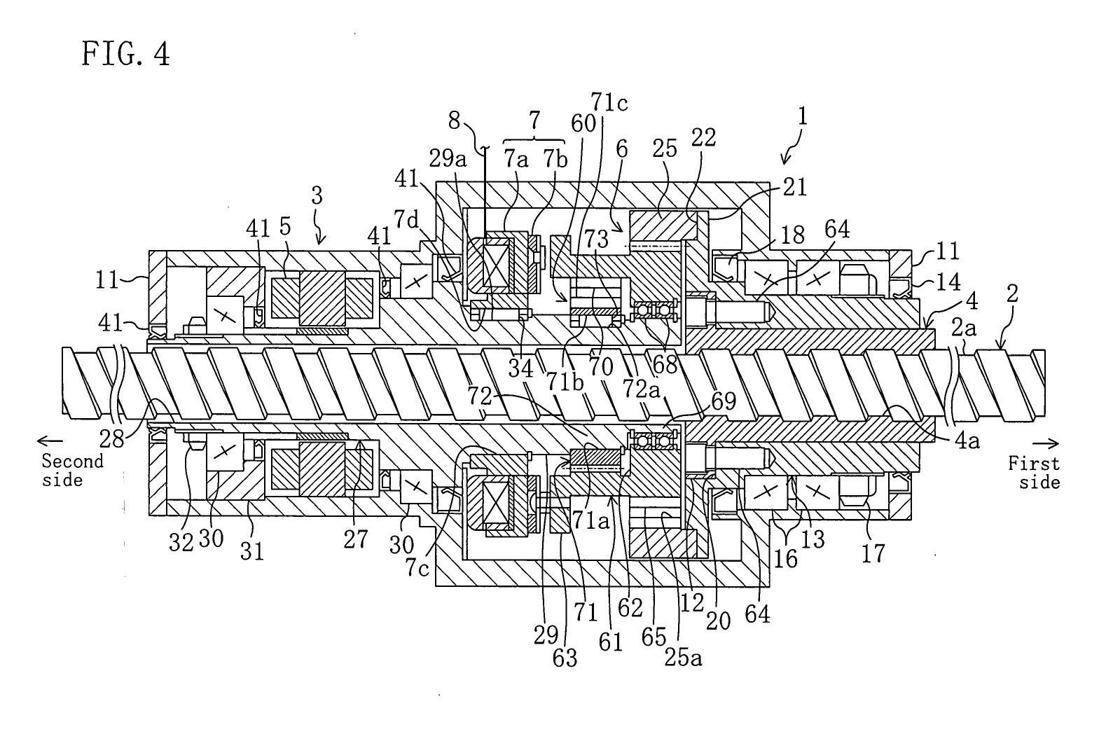

FIG. 4 shows a drive shaft moving device 1 according to embodiment 2 of the present invention. The moving device 1 of embodiment 2 includes a speed increasing mechanism 60, which is the difference from that of embodiment 1, and the other elements are the same. Hereinafter, the same elements as those of embodiment 1 are denoted by the same reference numerals, and the descriptions thereof are omitted.

Specifically, the first end of the output shaft 27 is provided with a cylindrical rotary member 61 which surrounds the output shaft 27. A first side end of the cylindrical rotary member 61 has an annular inward protrusion 62 which protrudes inwardly of the cylindrical rotary member 61. The other end (second side end) of the cylindrical rotary member 61 has an annular outward protrusion 63 which protrudes outwardly of the cylindrical rotary member 61

The cylindrical member 13 is fixedly fastened to the nut 4 by a bolt 64. The external surface of the first side end of the cylindrical rotary member 61 has teeth (first driver teeth) 65 all around the cylinder 61 at positions corresponding to the inward protrusion 62 such that the teeth 65 mesh with the teeth 25a of the internal gear 25 of the nut 4. The outside diameter of the first side end of the cylindrical rotary member 61 is smaller than the inside diameter of the internal gear 25. The number of teeth 65 of the cylindrical rotary member 61 (Z2) is smaller than the number of teeth 25a of the internal gear 25 (Z1). According to embodiment 2, the number of teeth 25a of the internal gear 25 (Z1) is, for example, 50, while the number of teeth 65 of the cylindrical rotary member 61 (Z2) is, for example, 49. According to embodiment 2, the teeth 25a of the internal gear 25 constitute the first follower teeth.

The internal surface of the inward protrusion 62 of the cylindrical rotary member 61 is provided with two bearings 68. A first eccentric part 69 provided at the first side end of the output shaft 27 is inserted through inner holes of the bearings 68. The cylindrical rotary member 61 is rotatably supported by the first eccentric part 69. The geometric center of the first eccentric part 69 is misaligned from the rotation axis of the output shaft 27. Therefore, the rotation center of the cylindrical rotary member 61 is eccentric from the rotation axis of the output shaft 27. The amount of the misalignment of the rotation center of the cylindrical rotary member 61 is set such that some of the teeth 65 of the cylindrical rotary member 61 mesh with some of the teeth 25a of the internal gear 25 of the cylindrical member 13. The internal surface of the cylindrical rotary member 61 has teeth (second follower teeth) 70 all around the internal surface at positions closer to the second side than the inward protrusion 62.

The output shaft 27 is provided with a spur gear 71 which is located inwardly of the cylindrical rotary member 61. The outside diameter of the spur gear 71 is smaller than the inside diameter of a portion of the cylindrical rotary member 61 in which the teeth 70 is provided. The number of teeth 71c of the spur gear 71, Z3, is larger than the number of teeth 70 of the cylindrical rotary member 61, Z4. According to embodiment 2, the number of teeth 71c of the spur gear 71 (Z3) is 30 while the number of teeth 70 of the cylindrical rotary member 61 (Z4) is 28.

The large diameter part 29 of the output shaft 27 has a second eccentric part 72 which is inserted through a central hole 71a of the spur gear 71. The geometric center of the second eccentric part 72 is misaligned from both the rotation axis of the output shaft 27 and the geometric center of the first eccentric part 69. The amount of this misalignment of the geometric center is set such that some of the teeth 71c of the spur gear 71 mesh with some of the teeth 70 of the cylindrical rotary member 61. The teeth 71c constitute second driver teeth. The internal surface of the central hole 71a of the spur gear 71 and the external surface of the second eccentric part 72 of the output shaft 27 have keyways 71b and 72a, respectively. A key 73 is inserted to the keyways 71b and 72a. With this, the spur gear 71 is fixed to the output shaft 27 and rotates according to the rotation of the output shaft 27 eccentrically with respect to the rotation center of the output shaft 27.

The outward protrusion 63 of the cylindrical rotary member 61 is provided with the clutch plate 7b.

In the moving device 1 having the above-described structure, when the controller 40 turns ON the electromagnetic clutch 7, the clutch plate 7b and the principal part 7a are integrated. As a result, the output shaft 27 is connected to the cylindrical rotary member 61. When the controller 40 turns ON the motor 5 so that the output shaft 27 starts rotating, the torque of the output shaft 27 is transmitted to the cylindrical rotary member 61 through the electromagnetic clutch 7, so that the cylindrical rotary member 61 rotates at a rotation speed equal to that of the output shaft 27. When the cylindrical rotary member 61 rotates, the internal gear 25 which is meshed with the teeth 65 of the cylindrical rotary member 61 rotates, and accordingly, the nut 4 rotates. In this process, the rotation speed of the nut 4 is reduced at the gear ratio of 1/50 which is set by the number of teeth 65 and the number of teeth 25a of the internal gear 25 to be lower than the rotation speed of the output shaft 27, while the torque of the nut 4 increases. As a result, the propulsion speed of the drive shaft 2 decreases, while the thrust of the drive shaft 2 increases. Thus, a sufficient pressing force can be obtained during the pressing process.

On the other hand, when the controller 40 turns OFF the electromagnetic clutch 7, the clutch plate 7b retreats from the principal part 7a so that the output shaft 27 is disconnected from the cylindrical rotary member 61. When the controller 40 turns ON the motor 5 so that the output shaft 27 starts rotating, the torque of the output shaft 27 is transmitted from the spur gear 71 to the cylindrical rotary member 61. In this process, the rotation speed of the cylindrical rotary member 61 is increased at the gear ratio set by the number of teeth 71c of the spur gear 71 (Z3) and the number of teeth 70 (Z4) to be higher than the rotation speed of the output shaft 27. When the cylindrical rotary member 61 rotates, the torque of the cylindrical rotary member 61 is transmitted to the nut 4 through the internal gear 25 and the cylindrical member 13. In this process, the rotation speed of the nut 4 is reduced at the gear ratio set by the teeth 65 and the internal gear 25 to be lower than the rotation speed of the cylindrical rotary member 61. In embodiment 2, the gear ratio between the spur gear 71 and the teeth 70 is set such that the rotation speed of the nut 4 is closer to that of the output shaft 27 when the electromagnetic clutch 7 is OFF as compared with a case where the electromagnetic clutch 7 is ON. Specifically, the rotation speed of the nut 4 is a 1/20 of the rotation speed of the output shaft 27. The ratio of the rotation speed of the nut 4 and the rotation speed of the output shaft 27 during the OFF period of the electromagnetic clutch 7 may be arbitrarily set by changing the numbers of Z1 to Z4.

Thus, in the drive shaft moving device 1 according to embodiment 2, the rotation speed of the nut 4 can be switched between two speeds when transmitting the torque of the output shaft 27 of the motor 5 to the nut 4. Therefore, the same effects as those of embodiment 1 can be achieved.

The rotation speed of the nut 4 can be set by changing the two gear ratios, the gear ratio between the output shaft 27 and the cylindrical rotary member 61 and the gear ratio between the cylindrical rotary member 61 and the nut 4. Thus, the flexibility in setting the rotation speed of the nut 4 is improved, and the versatility of the moving device 1 is further improved.

Although in the above-described examples of embodiments 1 and 2 the present invention is applied to a device for moving the press die P, the present invention is also applicable to machines other than the press molding machine, for example, cutting machines, press-fit machines, etc.

Although in the above-described examples of embodiments 1 and 2 the drive shaft 2 is formed by a trapezoidal screw shaft and the nut 4 is formed by a trapezoidal screw nut, the drive shaft 2 may be formed by a ball screw shaft and the nut 4 may be formed by a ball screw nut which meshes with the ball screw shaft.

For example, the number of teeth 71c of the spur gear 71 (Z3) may be set smaller than the number of teeth 70 of the cylindrical rotary member 61 (Z4) such that the spur gear 71 and the teeth 70 reduce the rotation speed of the cylindrical rotary member 61. The number of teeth 65 of the cylindrical rotary member 61 (Z2) may be set larger than the number of teeth 25a of the internal gear 25 (Z1) such that the teeth 65 and the internal gear 25 increases the rotation speed of the nut 4.

The speed reduction mechanism may be formed by a planetary gear train.

### INDUSTRIAL APPLICABILITY

As described above, a drive shaft moving device of the present invention is suitable for a machine which is required to change the propulsion speed or thrust during the travel of the drive shaft, for example, a press molding machine.

1. A drive shaft moving device, comprising: a principal part of the device through which a drive shaft is inserted, the drive shaft having a thread groove in its external surface; a nut provided inside the principal part of the device to engage with the thread groove of the drive shaft; and drive means for rotating the nut around the drive shaft, the drive means rotating the nut to move the drive shaft in an axial direction relative to the principal part of the device,
wherein the inside of the principal part of the device includes rotation speed switching means for switching the rotation speed of the nut among a plurality of rotation speeds when transmitting a torque from the drive means to the nut,
the nut has an annular part surrounding the drive shaft,
the drive means has an output shaft through which the drive shaft is inserted, and
the rotation speed switching means includes follower teeth formed by internal teeth provided on an inner periphery of the annular part, driver teeth provided on the outer periphery of the output shaft to mesh with the follower teeth, and clutching means integrally rotatable with the output shaft for switching the connection/disconnection between the output shaft and the nut.

2. The drive shaft moving device, comprising: a principal part of the device through which a drive shaft is inserted, the drive shaft having a thread groove in its external surface; a nut provided inside the principal part of the device to engage with the thread groove of the drive shaft; and drive means for rotating the nut around the drive shaft, the drive means rotating the nut to move the drive shaft in an axial direction relative to the principal part of the device,
wherein the inside of the principal part of the device includes rotation speed switching means for switching the rotation speed of the nut among a plurality of rotation speeds when transmitting a torque from the drive means to the nut,
the nut has an annular part surrounding the drive shaft,
the drive means has an output shaft through which the drive shaft is inserted, and
the rotation speed switching means includes a cylindrical rotary member supported rotatably around the output shaft, first follower teeth formed by internal teeth provided on an inner periphery of the annular part of the nut, first driver teeth provided on the outer periphery of the rotary member to mesh with the first follower teeth, second follower teeth provided on an inner periphery of the rotary member, second driver teeth provided on the outer periphery of the output shaft to mesh with the second follower teeth, and clutching means integrally rotatable with the output shaft for switching the connection/disconnection between the output shaft and the rotary member.

3. The drive shaft moving device of claim 1 or 2, wherein the drive shaft is located to penetrate through the rotation speed switching means.

4. The drive shaft moving device of claim 3, wherein the rotation speed switching means includes a speed reduction mechanism for reducing the rotation speed of an output shaft of the drive means.

5. (canceled)

6. (canceled)
